(19) United States
(12) Patent Application Publication
(10) Pub. No.: US 2013/0000097 A1
(43) Pub. Date: Jan. 3, 2013

(54) RACEWAY MOLDING SYSTEM DEVICE AND METHOD

(76) Inventor: Angelo J. Pino, New York, NY (US)

(21) Appl. No.: 13/492,457

(22) Filed: Jun. 8, 2012

Related U.S. Application Data
(60) Provisional application No. 61/502,582, filed on Jun. 29, 2011.

(51) Int. Cl. F16L 27/00; B23P 11/00

(52) U.S. Cl. 29/428; 285/149.1

(57) ABSTRACT

Provided is a system, device and method for providing raceway molding covering.

This application claims priority to U.S. provisional patent application Ser. No. 61/502,582, filed 29 Jun. 2011, the complete disclosure of which is incorporated herein by reference.

### FIELD OF THE INVENTION

The present invention generally relates to an adjustable angle corner molding that adjusts to different corner angles between adjacent walls and a method of providing a corner molding.

### BACKGROUND OF THE INVENTION

Most office buildings and many homes are faced with the challenge of running power and data cables throughout the facility. Such cables are often enclosed in raceway molding that houses the cables and that may extend along (and are fastened to) walls, ceilings and floors. Installation of such molding can be challenging when the molding must be installed at a corner - especially a corner that is not ninety degrees—since the molding cover must be cut to the appropriate angle of the corner (e.g., often mitre cut). What is needed is a cost and time efficient means for installing moldings at corners.

### SUMMARY OF THE INVENTION

An objective of the invention is to provide an adjustable angle corner molding that is adjustable to provide an improved appearance corner molding in an efficient manner.

This objective and other objectives are obtained by an adjustable angle corner molding configured to cover one or more cables and connect a first molding raceway to a second molding raceway comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a channel sized to enclose cables when the second molding portion is placed against a wall, wherein the first side and the second side of the second molding portion are attached to opposite sides of the top portion at an angle; and
a pivoting member pivotally attaching the top side of the first molding portion to the top side of the second molding portion, wherein the first side of the first portion extends beyond the top side of the first molding portion and the first side of the second molding portion extends beyond the top side of the second molding portion so that the first side of the first or second molding portion overlaps the first side of the other molding portion and covers an area from the pivoting member to a corner between adjacent walls when the corner molding is placed in a corner and the pivoting member is constructed to adjust to different angles of corners between adjacent walls.

The objectives are also obtained by a method of using a corner molding to join a first molding raceway to a second molding raceway and being constructed to cover cables at a corner between adjacent walls, the method comprising:
providing an adjustable angle corner molding configured to cover one or more cables comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a raceway channel sized to enclose cables when the second molding portion is placed against a wall, wherein the first side and the second side of the second molding portion are attached to opposite sides of the top portion at an angle; and
a pivoting member pivotally attaching the top side of the first molding portion to the top side of the second molding portion, wherein the first side of the first molding portion extends beyond the top side of the first molding portion and the first side of the second molding portion extends beyond the top side of the second molding portion so that the first side of the first or second molding portion overlaps the first side of the other molding portion and covers an area from the pivoting member to a corner between adjacent first and second walls when the corner molding is placed in a corner and the pivoting member constructed to adjust to different angles of corners between the adjacent walls;
adjusting an angle between the first molding portion and the second portion to substantially match an angle of a corner between adjacent walls;
trimming the first side portions of the first and second molding portions to match the angle and so that the trimmed first side portions abut the adjacent walls; and
installing the corner molding so that the first molding portion joins a first molding raceway along the first wall with a second molding raceway along the second wall at the corner between the first and second walls.

The objectives are further obtained by an adjustable angle corner molding configured to cover one or more cables comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a raceway channel sized to enclose cables when the second molding portion is placed against a wall, wherein the first side and the second side of the second molding portion are attached to opposite sides of the top portion at an angle;
a pivoting member pivotally attaching the first side of the first molding portion to the first side of the second molding portion.

### BRIEF DESCRIPTION OF THE DRAWINGS

FIG. 1 illustrates an adjustable corner molding;

FIG. 2 illustrates an adjustable corner molding;

FIG. 3 illustrates an adjustable corner molding;

FIG. 4 illustrates an adjustable corner molding; and

FIG. 5 illustrates an adjustable corner molding.

### DETAILED DESCRIPTION OF ILLUSTRATIVE EMBODIMENTS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown.

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description.

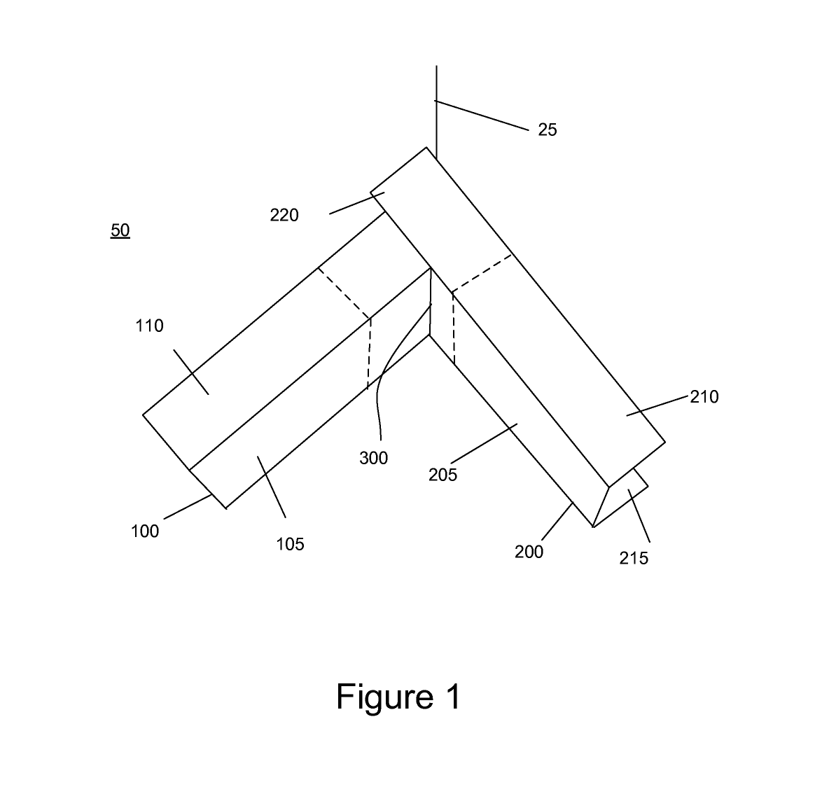

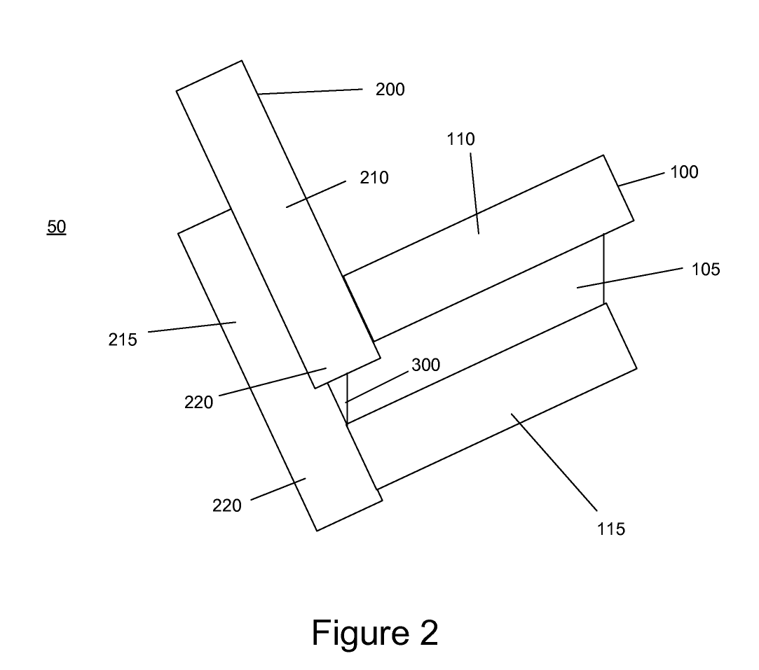

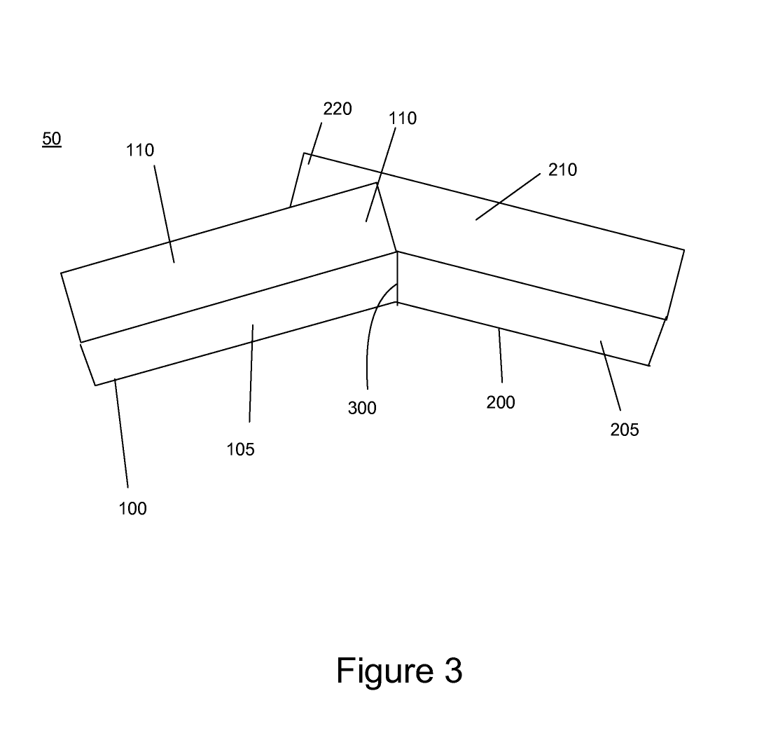

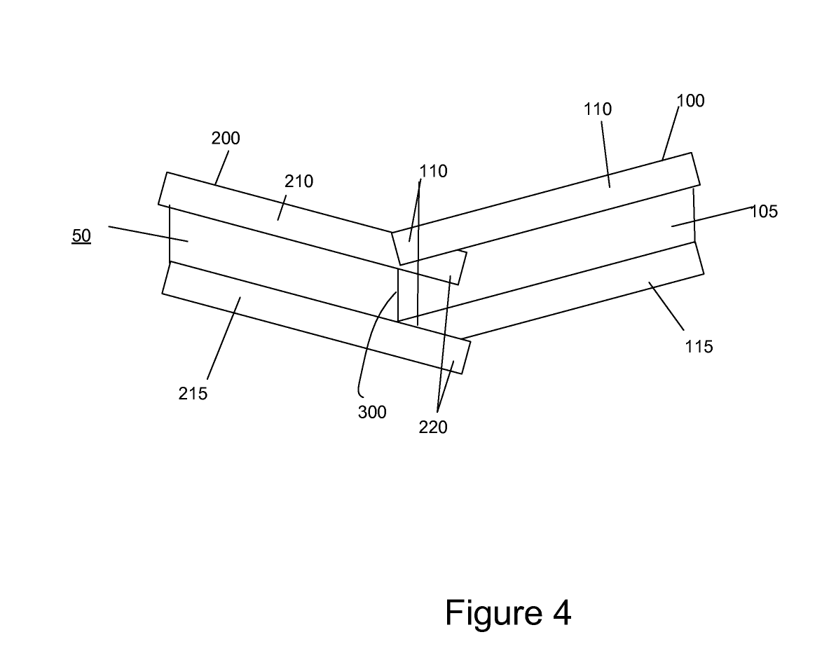

FIGS. 1-4 depict various views and configurations of example embodiments of an adjustable corner molding 50 of the present invention. This example embodiment includes a first molding portion 100 and a second molding portion 200 that are pivotally coupled together using a pivoting member 300 that comprised any suitable pivoting or hinge mechanism include, for example purposes, a mechanical hinge (e.g., adhesively attached to the inside/underside surfaces of the top sides 105 and 205), rubber or other material (attached to both portions 100 and 200), flexible metal or other material (e.g., from which all or a portion of the first portion 100 and second portion 200 are constructed), etc. The first portion 100 includes a top side 105 and a first side 110 and a second side 115. The second portion 200 includes a top side 205 and a first side 210 and a second side 215. The pivoting member 300 allows the angle between the first portion 100 and the second portion 200 (which is about 90 degrees in FIG. 1) to be easily adjusted at installation to match the angle of the corner 25. The adjustable corner molding 50 can be formed from any suitable raceway materials, such as polymeric materials, metal, wood, or composites. Suitable raceway materials are now well known.

At installation, the molding cover 50 may be installed at the corner 25. In FIG. 1, the dashed lines illustrate an example as to a location to which the underneath molding cover may be installed. The underneath molding cover may not extend to the corner 25 if desired, although the raceway that holds the cable(s) may extend to the corner 25. The ends 220 of side portions 210 and 215 may be trimmed (e.g., by the installer) to abut against the installation surface (e.g., wall) and/or interface with first and second molding raceways (not shown) along the first and second walls. In some embodiments, the ends of side portions 105 and 115 (at the corner end) also may be trimmed (e.g., by the installer) to abut against the installation surface (e.g., wall) and/or interface with the first and second raceways. In this manner, the molding 50 can be used to easily and quickly connect a first raceway along a first wall to a second raceway along a second wall at an inside or outside corner.

Some embodiments also may include a raceway for holding cables that includes multiple channels and that attaches to the way via any suitable mechanism including, for example, adhesive.

Embodiments of the adjustable corner molding 50 may be removably attached to the raceway and/or the underneath molding (if present) via any suitable method such as via a hinge, friction fit, snap-lock, clip, adhesive, screw, etc.

The molding corner 50 may have any suitable external appearance including for example, a downspout exterior appearance. The molding 50 (or associated raceway) may include a bend radius protector mechanism to maintain the minimum bend radius of 1″.

The embodiment of the molding 50 illustrated may be configured to pivot from about 1 degree to about 360 degrees by trimming the ends 120 and 220 as needed. The molding 50 may be installed on an outside corner or on an inside corner as illustrated. Thus, the length of the first sides 110 and 220 are preferably such that when the molding 50 is installed on an inside corner, the area between the pivotable member 300 and corner between the adjacent walls is covered. The first sides 110 and 220 can be trimmed down when the molding 50 is installed on an outside corner between adjacent walls. The second sides 115 and 215 can be similarly sized and trimmed in the same manner as the first sides 110 and 220.

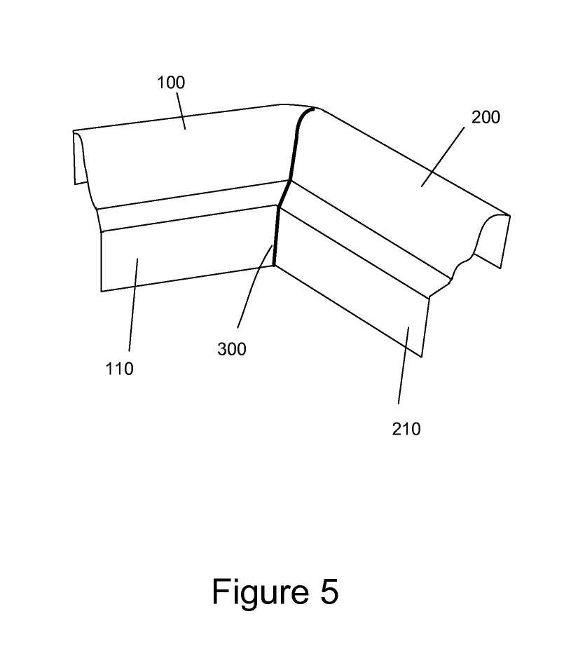

FIG. 5 illustrates another example embodiment in which the first side 110 of the first portion 100 is pivotally connected to the first side 210 of the second portion 200 (instead of the top sides being pivotally connected). The two portions 100 and 200 thus may pivot in the same plane as the surface to which the embodiment will be mounted. This example embodiment may be installed where two or three surfaces meet each other (e.g., on a first wall where the first wall meets the ceiling and another wall). Thus, in this example embodiment, the top side and the other (non-pivotally connected) side of either or both portions may need to be trimmed during installation.

While the embodiments described above has three surfaces (top side, first side and second side) other embodiments may have only two surfaces, four surfaces, or any number of surfaces and may be designed to visually match the molding over which it will be installed (e.g., number of surfaces, shape, color, etc.).

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. An adjustable angle corner molding configured to cover one or more cables and connect a first molding raceway to a second molding raceway comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a channel sized to enclose cables when the second molding portion is placed against a wall, wherein the first side and the second side of the second molding portion are attached to opposite sides of the top portion at an angle; and
a pivoting member pivotally attaching the top side of the first molding portion to the top side of the second molding portion, wherein the first side of the first portion extends beyond the top side of the first molding portion and the first side of the second molding portion extends beyond the top side of the second molding portion so that the first side of the first or second molding portion overlaps the first side of the other molding portion and covers an area from the pivoting member to a corner between adjacent walls when the corner molding is placed in a corner and the pivoting member is constructed to adjust to different angles of corners between adjacent walls.

2. The corner molding according to claim 1, wherein said first side and second side of said first portion are attached to said top side substantially orthogonally.

3. The corner molding according to claim 1, wherein said first side and second side of said second portion are attached to said top portion substantially orthogonally.

4. The corner according to claim 1, wherein the device is configured to be removably attached to a molding configured to hold cables.

5. The corner molding according to claim 2, wherein the second side of the first molding portion extends beyond the top side of the first molding portion and the second side of the second molding portion extends beyond the top side of the second molding portion so that the second side of the first or second molding portion overlaps the second side of the other molding portion and covers an area from the pivoting member to a corner between adjacent walls when the corner molding is placed in a corner and the pivoting mount constructed to adjust to different angles of corners between adjacent walls.

6. A method of using a corner molding to join a first molding raceway to a second molding raceway and being constructed to cover cables at a corner between adjacent walls, the method comprising:
providing an adjustable angle corner molding configured to cover one or more cables comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a raceway channel sized to enclose cables when the second molding portion is placed against a wall, wherein the first side and the second side of the second molding portion are attached to opposite sides of the top portion at an angle; and
a pivoting member pivotally attaching the top side of the first molding portion to the top side of the second molding portion, wherein the first side of the first molding portion extends beyond the top side of the first molding portion and the first side of the second molding portion extends beyond the top side of the second molding portion so that the first side of the first or second molding portion overlaps the first side of the other molding portion and covers an area from the pivoting member to a corner between adjacent first and second walls when the corner molding is placed in a corner and the pivoting member constructed to adjust to different angles of corners between the adjacent walls;
adjusting an angle between the first molding portion and the second portion to substantially match an angle of a corner between adjacent walls;
trimming the first side portions of the first and second molding portions to match the angle and so that the trimmed first side portions abut the adjacent walls; and
installing the corner molding so that the first molding portion joins a first molding raceway along the first wall with a second molding raceway along the second wall at the corner between the first and second walls.

7. The method according to claim 6, wherein the second side of the first molding portion extends beyond the top side of the first molding portion and the second side of the second molding portion extends beyond the top side of the second molding portion so that the second side of the first or second molding portion overlaps the second side of the other molding portion and covers an area from the pivoting member to a corner between adjacent walls when the corner molding is placed in a corner and the pivoting member is constructed to adjust to different angles of corners between adjacent walls, the method further comprising trimming the second sides of the first and second molding portions to match the angle and so that the trimmed second sides abut the adjacent walls.

8. An adjustable angle corner molding configured to cover one or more cables comprising:
a first molding portion comprising a first side, a second side, and a top side defining a raceway channel sized to enclose cables when the first molding portion is placed against a wall, wherein the first side and the second side of the first molding portion are attached to opposite sides of the top side at an angle;
a second molding portion comprising a first side, a second side, and a top portion defining a raceway channel sized to enclose cables when the second molding portion is placed against a wall, wherein the first side and the second side of the second molding portion are attached to opposite sides of the top portion at an angle; and
a pivoting member pivotally attaching the first side of the first molding portion to the first side of the second molding portion.
